(19) United States
(12) Patent Application Publication
(10) Pub. No.: US 2010/0007823 A1
(43) Pub. Date: Jan. 14, 2010

(54) BRIGHTNESS ENHANCEMENT FILM AND LIQUID CRYSTAL DISPLAY DEVICE

(76) Inventors: Manabu Haraguchi, Tokyo (JP); Koya Kawabata, Tokyo (JP)

Correspondence Address: BIRCH STEWART KOLASCH & BIRCH, PO BOX 747, FALLS CHURCH, VA, 22040-0747, US

(21) Appl. No.: 12/374,057

(22) PCT Filed: Jul. 31, 2007
(86) PCT No.: PCT/JP2007/065005

§ 371 Date: Jan. 16, 2009

(30) Foreign Application Priority Data
Jul. 31, 2006 (JP) 2006-208625

(51) Int. Cl. G02F 1/13363; G02B 5/30

(52) U.S. Cl. 349/98; 359/497

(57) ABSTRACT

Provided are a brightness enhancement film and a liquid crystal display device which has a high ability for enhancing a luminance, has a more excellent ability for improving a luminance unevenness than conventional ones and may reduce an occurrence of a color unevenness. The brightness enhancement film wherein a circular polarization separation element, an optically anisotropic element wherein a retardation in an in-plane direction Re is about one fourth of a transmitting light and a retardation in a thickness direction Rth is less than 0 nm and a periodic structure member having a repeating structure on a surface thereof are integrated in this order, and the liquid crystal display device comprising the same.

### TECHNICAL FIELD

The present invention relates to a brightness enhancement film used for an image display device such as a liquid crystal display device, and a liquid crystal display device.

### BACKGROUND ART

In liquid crystal display devices, natural light emitted from a backlight has conventionally been introduced as the natural light to a liquid crystal cell. Recently, large size and high resolution of the liquid crystal display devices is required. Thus there is a demand to enhance a luminance of the backlight, and technology related thereto has been studied. It is also studied to polarize the light from the backlight.

For example, it has been studied to provide the liquid crystal display device with a brightness enhancement film on a back side of liquid crystal cell with respect to a viewing side, i.e., on a surface facing the backlight. The brightness enhancement film is a film having a property wherein, when light enters from a light source such as the backlight of the liquid crystal display device, a linearly polarized light with a predetermined polarization axis or a circularly polarized light in a predetermined direction is transmitted and other sort of light is reflected.

Among the light from the light source such as the backlight coming into the brightness enhancement film, a part of light in such a predetermined polarization state is transmitted. Meanwhile, the light not having the predetermined polarization state is not transmitted, and are reflected and returned to the backlight. The polarization state of the lights reaching back to the backlight is reversed by a reflecting plate provided therein. The light whose polarization state has been reversed may again enter the brightness enhancement film. Among the light, those in the predetermined polarization state may then pass through the brightness enhancement film. Repetition of this cycle may increase an amount of the light which passes through the brightness enhancement film, and thus increase the amount of polarized light having a capability of passing through polarization plates and available for the liquid crystal display device, resulting in enhancement of the luminance of the liquid crystal display device.

As examples of the brightness enhancement film, there have been proposed linear polarization separation elements having a property that linearly polarized light in the predetermined polarization axis passes therethrough and other sort of light is reflected thereby, such as multilayer thin films of dielectric materials and multilayer laminates of thin films having varied refraction index anisotropy; and circular polarization separation elements having a property that either one of anticlockwise and clockwise circularly polarized light passes therethrough and the other light is reflected, such as films of orientated cholesteric liquid crystal polymers and the oriented liquid crystal layer supported on a film substrate.

When the brightness enhancement film which allows a circularly polarized light to pass therethrough, such as cholesteric liquid crystal layer, is employed, the circularly polarized light that has passed therethrough may then be directly introduced to the polarizing plate. However, it is preferable that the circularly polarized light is converted into the linearly polarized light with the use of an optically anisotropic element such as a phase shift plate and the converted light is then introduced to the polarizing plate because an absorption loss in the polarizing plate is reduced thereby. As the phase shift plate, a ¼ wavelength plate is capable of converting the circular polarization into the linear polarization.

Furthermore, for the purpose of enhancing display luminance and eliminating luminance unevenness, a sheet having a prism row on its surface, i.e., a prism sheet or a diffusion sheet is used in combination with the brightness enhancement film.

For example, Japanese Patent No. 3416302 discloses a backlight device for a liquid crystal display wherein the reflecting plate, the light source, a circularly polarizing plate composed of a cholesteric liquid crystal layer exhibiting a selected reflection in the range of 400 to 700 nm, a ¼ wavelength plate and a diffusion plate or a light-harvesting plate are disposed in this order. JP Hei-10-232313-A (corresponding application: U.S. Pat. No. 6,559,911) discloses a polarization separation film wherein a prism layer which alters traveling direction of light is laminated on a surface of an optical rotation selective layer of a film laminating the optical rotation selective layer and a λ/4 phase shift layer.

According to these constitution in the prior art, selective reflection of the circularly polarizing plate allows only the particular circular polarization to pass among the light emitted from the light sources and then the ¼ wavelength plate converts the light into a linearly polarized light. Meanwhile, the light reflected by the circularly polarizing plate is diffused and reflected by the reflecting plate in the backlight device and comes again to the circularly polarizing plate. A part of the light which has now become in a state of the circular polarization which can pass through the circularly polarizing plate passes through the circularly polarizing plate, and is then converted into the linearly polarized light. The light converted into the linearly polarized light and emitted from a ¼λ plate may then be allowed to pass through the diffusion plate, the light-harvesting plate or the prism layer, to further improve luminance and luminance unevenness.

However, the aforementioned constitutions in the prior art are not capable of sufficiently reduce the luminance unevenness in the backlight device such as a direct-type backlight device in which the luminance unevenness is prone to be increased. In addition, there has been tendency of color unevenness upon viewing from an oblique direction which is caused by the optical property of the circularly polarizing plate and the ¼ wavelength plate. Due to the prism layer, such unevenness may further cause color unevenness upon viewing from the front direction.

### DISCLOSURE OF INVENTION

### Problem to be Solved by the Invention

Therefore, it is an object of the present invention to provide a brightness enhancement film which has a high ability for enhancing a luminance, has a higher ability for improving a luminance evenness than those of conventional ones, and can reduce an occurrence of a color unevenness.

### Means for Solving Problem

As a result of an extensive study for solving the aforementioned problems, the present inventors have found that an optically anisotropic element having a particular retardation property integrated with a circular polarization separation element and a periodic structure member a particular order may result in remarkable effects such as a significant reduction of a luminance unevenness and an improvement of a color evenness, in addition to conventional effects such as an enhancement of the luminance. Thus the present inventors have completed the present invention.

That is, the following is provided by the present invention:

(1) A brightness enhancement film comprising:

a circular polarization separation element,

an optically anisotropic element wherein a retardation in an in-plane direction Re is about one fourth of a transmitting light and a retardation in a thickness direction Rth is less than 0 nm, and

a periodic structure member having a repeating structure on a surface thereof,

said circular polarization separation element, said optically anisotropic element and said periodic structure member being integrated in this order.

(2) The brightness enhancement film according to (1) wherein said circular polarization separation element has a resin layer having a cholesteric regularity.
(3) The brightness enhancement film according to (1) or (2) wherein said repeating structure in said periodic structure member has a repeating unit of a linear prism shape, a cylindrical shape or a pyramid shape.
(4) The brightness enhancement film according to any one of (1) to (3) wherein a ridge of the repeating structure in said periodic structure member is given R-modification.
(5) The brightness enhancement film according to any one of (1) to (4) wherein a surface of the repeating structure in said periodic structure member is roughened.
(6) The brightness enhancement film according to any one of (1) to (5) wherein said periodic structure member is composed of a material having a light diffusibility.
(7) A liquid crystal display device comprising the brightness enhancement film according to any one of (1) to (6).

### EFFECT OF THE INVENTION

The brightness enhancement film of the present invention has ability for enhancing the luminance, higher ability for improving the luminance has evenness than the conventional ones, can reduce the occurrence of the color unevenness, can be produced easily because of its simple structure, and is easily attached to the display device. Therefore, this film is useful as a constituent of the display devices such as liquid crystal display devices for remarkably enhancing the luminance.

### BRIEF DESCRIPTION OF DRAWINGS

FIG. 1 is a perspective view schematically showing a construction of an assembly in prior art including the brightness enhancement film of the present invention in Examples and Comparative Examples (prior art).

FIG. 2 is a perspective view showing an example of a periodic structure member constituting the brightness enhancement film of the present invention.

FIG. 3 is a cross-sectional view of the periodic structure member shown in FIG. 2.

FIG. 4 is a perspective view showing another example of a periodic structure member constituting the brightness enhancement film of the present invention.

FIG. 5 is a perspective view showing another example of a periodic structure member constituting the brightness enhancement film of the present invention.

FIG. 6 is a perspective view showing another example of a periodic structure member constituting the brightness enhancement film of the present invention.

FIG. 7 is a perspective view showing another example of a periodic structure member constituting the brightness enhancement film of the present invention.

FIG. 8 is a perspective view showing another example of a periodic structure member constituting the brightness enhancement film of the present invention.

FIG. 9 is a perspective view showing another example of a periodic structure member constituting the brightness enhancement film of the present invention.

### BEST MODE FOR CARRYING OUT THE INVENTION

The brightness enhancement film of the present invention has a circular polarization separation elements an optically anisotropic element having a particular retardation property which will be described later, and a periodic structure member having a repeating structure on a surface thereof. The circular polarization separation element, the optically anisotropic element and the periodic structure member usually have approximately flat platy or film-like shapes, and are integrated in this order to constitute the brightness enhancement film as described in detail later.

As the circular polarization separation element to be used for the present invention, there are a variety of elements having a circular polarization separation property, i.e., a property to allow a specific circularly polarized light to pass therethrough and reflect other light in at least a partial region of a visible wavelength range. In particular, it is preferable that the circular polarization separation element has a circular polarization separation property also in an infrared wavelength range in addition to the visible wavelength range. More specifically, it is preferable to have a circular polarization separation property at 400 to 730 nm and more preferably at 400 to 770 nm. Having the circular polarization separation property herein means a property to allow a particular circularly polarized light to pass therethrough and reflect at least a part of other light, counting out the effect of interface light reflection.

As the circular polarization separation element, those having a resin layer having a cholesteric regularity are preferable. The resin layer having a cholesteric regularity is preferably a non-liquid crystal layer. More specifically, preferable are resin layers in which a molecular orientation of a cholesteric regularity is fixed, such as those obtained by polymerizing a polymerizable liquid crystal compound.

Examples of the polymerizable liquid crystal compound may include compounds represented by the following formula I:

R³—C³-D³-C⁵-M-C⁶-D⁴-C⁴—R⁴ (Formula I)

wherein, R³ and R⁴ are reactive groups and each independently represents a group selected from the group consisting of an acryl group, a methacryl group, an epoxy group, a thioepoxy group, an oxetane group, a thietanyl group, an aziridinyl group, a pyrrol group, a vinyl group, an allyl group, a fumarate group, a cinnamoyl group, an oxazoline group, a mercapto group, an isocyanate group, an isothiocyanate group, an amino group, a hydroxyl group, a carboxyl group and a alkoxysilyl group; D³ and D⁴ represent a group selected from the group consisting of a single bond, a straight or branched alkyl group having 1 to 20 carbon atoms and a straight or branched alkylene oxide group having 1 to 20 carbon atoms; C³ to C⁶ represent a group selected from the group consisting of a single bond, —O—, —S—, —S—S—, —CO—, —CS—, —OCO—, —CH₂—, —OCH₂—, —C═N—N═C—, —NHCO—, —OCOO—, —CH₂COO— and —CH₂OCO—; and M represents a mesogenic group, and is specifically configured by binding 2 to 4 skeletons selected from the group consisting of azomethines, azoxys, phenyls, biphenyls, terphenyls, naphthalenes, anthracenes, benzoate esters, cyclohexane carboxylate phenyl esters, cyanophenyl cyclohexanes, cyano-substituted phenylpyrimidines, alkoxy-substituted phenylpyrimidines, phenyldioxanes, tolans and alkenylcyclohexylbenzonitriles, which are not substituted or may have a substituent(s), with binding group(s) such as —O—, —S—, —S—S—, —CO—, —CS—, —OCO—, —CH₂—, —OCH₂—, —C═N—N═C—, —NHCO—, —OCOO—, —CH₂COO— and —CH₂OCO—.

Examples of the substituents which the mesogenic group M can have may include a halogen atom, an alkyl group having 1 to 10 carbon atoms which may have a substituent, a cyano group, a nitro group, —O—R⁵, —O—C(═O)—R⁵, —C(═O)—O—R⁵, —O—C(═O)—O—R⁵, —NR⁵—C(═O)—R⁵, —C(═O)—NR⁵ or —O—C(═O)—NR⁵. R⁵ represents a hydrogen atom or an alkyl group having 1 to 10 carbon atoms. When R⁵ represents the alkyl group, —O—, —S—, —O—C(═O)—, —C(═O)—O—, —O—C(═O)—O—, —NR⁶—C(═O)—, —C(═O)—NR⁶—, —NR⁶— or —C(═O)— may lie in the alkyl group (but the cases in which 2 or more of each O— and —S— lie adjacently are excluded). R⁶ represents a hydrogen atom or an alkyl group having 1 to 6 carbon atoms. Examples of the substituents in the “alkyl group having 1 to 10 carbon atoms which may have the substituents” may include a halogen atom, a hydroxyl group, a carboxyl group, a cyano group, an amino group, an alkoxy group having 1 to 6 carbon atoms, an alkoxyalkoxyl group having 2 to 8 carbon atoms, an alkoxyalkoxyalkoxy group having 3 to 15 carbon atoms, an alkoxycarbonyl group having 2 to 7 carbon atoms, an alkylcarbonyloxy group having 2 to 7 carbon atoms and an alkoxycarbonyloxy group having 2 to 7 carbon atoms.

The method for polymerizing the polymerizable liquid crystal compound to produce the resin layer having the cholesteric regularity is not particularly limited, and an example thereof may be a method in which a composition containing the polymerizable liquid crystal compound is applied on a support substrate to which, if necessary, an orientation film formation and a rubbing treatment have been given, and then the compound is polymerized. If necessary, a plurality of resin layers may be provided by repeating steps of applying and polymerizing, or by providing a plurality of laminates each having the resin layer and the support substrate, the laminates being integrated by adhesion to configure a plurality of resin layers. By providing a plurality of resin layers having a varied reflection bandwidth, it is possible to obtain a circular polarization separation element having a wide reflection bandwidth.

The composition containing the polymerizable liquid crystal compound may contain crosslinking agents, photopolymerization initiators, surfactants, chiral agents, solvents, polymerization inhibitors for enhancing a pot life, and antioxidants, ultraviolet light absorbers and light stabilizers for enhancing a durability in addition to the polymerizable liquid crystal compound. Application of the composition may be performed by publicly known methods such as reverse gravure coating, direct gravure coating, die coating and bar coating.

Polymerization of the polymerizable liquid crystal compound in the composition may be performed by one or more steps of warming and/or light irradiation. The warming may be specifically performed at 40 to 140° C. for one second to three minutes. The light used for the light irradiation in the present invention includes not only visible light but also ultraviolet light and other electromagnetic waves. The light irradiation may be specifically performed at a wavelength of 200 to 500 nm for 0.01 seconds to 3 minutes. It is possible to perform a multiple steps of ultraviolet light irradiation/warming including, for example, irradiation of the faint ultraviolet light in an integrated amount of 0.01 to 50 mJ/cm² and warming, whereby a circular polarization separation element having a wide reflection bandwidth may be obtained. For example, after performing one or more series of the faint ultraviolet light irradiation/warming, warming and/or the light irradiation for finally curing the polymerizable liquid crystal compound may be performed, to obtain a resin layer having a wide reflection bandwidth. When the circular polarization separation element contains a plurality of resin layers, it is preferable that the multiple series of the ultraviolet light irradiation/warming are performed for each of all the layers, to extend the reflection bandwidth of each layer.

In the optically anisotropic element used for the present invention, the retardation Re in its in-plane direction (sometimes abbreviated as “Re”) is about one fourth of a transmitting light and the retardation in a thickness direction Rth (sometimes abbreviated as “Rth”) is less than 0 nm. The wavelength range of the transmitting light may be a desired range required in the brightness enhancement film, and specifically is for example 400 to 700 nm. “The retardation in the in-plane direction Re is about one fourth of the transmitting light” refers to that the Re value is within ±65 nm, preferably ±30 nm and more preferably ±10 nm from the ¼ value of the center value of the wavelength range of the transmitting light. The value of the retardation in the thickness direction Rth may be preferably −30 nm to −1000 nm and more preferably −50 nm to −300 nm at the center value of the wavelength range of the transmitting light. By employing the optically anisotropic element having such an Re value and Rth value, it is possible to reduce the color unevenness of emitting light while improvement of luminance and reduction of luminance unevenness is simultaneously achieved.

In the present invention, the retardation in the in-plane direction Re is a value represented by the formula I: Re=(nx−ny)×d, wherein nx represents the refraction index in the direction perpendicular to the thickness direction (in-plane direction) which is the direction which gives the maximum refraction index, ny represents the refraction index in the direction perpendicular to the thickness direction (in-plane direction) which is the direction orthogonal to nx, and d represents a film thickness. The retardation in the thickness direction Rth is a value represented by the formula II: Rth={(nx+ny)/2−nz}×d, wherein nx represents the refraction index in the direction perpendicular to the thickness direction (in plane direction) which is the direction which gives the maximum refraction index, ny represents the refraction index in the direction perpendicular to the thickness direction (in-plane direction) which is the direction orthogonal to nx, nz represents the refraction index in the thickness direction and d represents the film thickness.

In the present invention, the retardation in the in-plane direction Re and the retardation in the thickness direction Rth are determined by measuring the optically anisotropic element in lattice points throughout the element with 100 mm intervals in its longitudinal direction and crosswise direction (when the length in the longitudinal direction or a crosswise direction is less than 200 mm, three points with equal intervals are designated in that direction) using a commercially available phase shift measurement apparatus, and calculating their average values.

Materials which compose the optically anisotropic element are not particularly limited, and those having a layer composed of a styrene based resin may be preferably used. The styrene based resin referred to herein is a polymer resin having a styrene structure as a portion or all of repeating units, and examples thereof may include polystyrene, or copolymers of styrene-based monomers with other monomers, wherein examples of the stylene-based monomers may be styrene, α-methylstyrene, o-methylstyrene, p-methylstyrene, p-chlorostyrene, p-nitrostyrene, p-aminostyrene, p-carboxystyrene and p-phenylstyrene whereas examples of other monomers may be ethylene, propylene, butadiene, isoprene, acrylonitrile, methacrylonitrile, α-chloroacrylonitrile, methyl acrylate, methyl methacrylate, ethyl acrylate, ethyl methacrylate, acrylic acid, methacrylic acid, maleic acid anhydrate and vinyl acetate. Among them, polystyrene or the copolymer of styrene with maleic acid anhydrate may be used suitably.

The molecular weight of the aforementioned styrene based resin is appropriately selected in accordance with the intended use, and is usually 10,000 to 300,000, preferably 15,000 to 250,000 and more preferably 20,000 to 200,000 as a weight average molecular weight (Mw) equivalent to polyisoprene measured by gel permeation chromatography using cyclohexane as the solvent.

The optically anisotropic element preferably has a multilayer structure of the layer composed of the styrene based resin and another layer containing thermoplastic resin. By having such a multilayer structure, it is possible to obtain an element having optical properties attributed to the styrene based resin and a mechanical strength attributed to the thermoplastic resin. Examples of the thermoplastic resin may include resins having an alicyclic structure, methacryl resins, polycarbonate, copolymer resins composed of acrylate ester and vinyl aromatic compound, copolymer resins composed of methacrylate ester and vinyl aromatic compound and polyether sulfone. Among them, the resin having an alicyclic structure and the methacryl resin may be used suitably.

The resin having an alicyclic structure is an amorphous olefin polymer having a cycloalkane structure in a main chain and/or a side chain. Specific examples thereof may include (1) norbornene based polymers, (2) monocyclic olefin based polymers, (3) cyclic conjugated diene based polymers, (4) vinyl alicyclic hydrocarbon polymers, and hydrogenated products thereof. Among them, the norbornene based polymer is preferable in terms of transparency and molding property. Examples of these resins having the alicyclic structure are described in JP Hei-05-310845-A, JP Hei-05-097978-A and U.S. Pat. No. 6,511,756.

Examples of the norbornene based polymers may specifically include ring opening polymers of norbornene based monomers, ring opening copolymers of the norbornene based monomer with another ring opening polymerizable monomer, hydrogenated products thereof, addition polymers of norbornene based monomers and addition copolymers of the norbornene based monomer with another addition polymerizable monomer.

The methacryl resin is a polymer composed mainly of methacrylate ester, and specific examples thereof may include homopolymers of methacrylate ester and copolymers of methacrylate ester with another monomer. Usually, alkyl methacrylate is used as methacrylate ester. When the copolymer is made, acrylate ester, an aromatic vinyl compound and a vinyl cyan compound may be used as another monomer to be copolymerized with methacrylate ester.

A preferable specific embodiment of the optically anisotropic element used for the present invention may be a stretched multilayer film obtained by stretching a multilayer film obtained by laminating a film (layer b) composed of a composition of a methacrylate ester polymer on both surfaces of a film (layer a) composed of a polystyrene resin. This specific embodiment will be described hereinbelow.

As the polystyrene resin which composes the layer a, it is possible to use the same ones as in the aforementioned “styrene based resins”.

The glass transition temperature of the polystyrene resin which composes the layer a is preferably 120° C. or above, more preferably 120 to 200° C. and still more preferably 120 to 140° C.

The composition of the methacrylate ester polymer which composes the layer b is a composition containing the methacrylate ester polymer, and contains methacrylate ester polymer (E) and particles (F).

The methacrylate ester polymer (E) is a polymer composed mainly of methacrylate ester (M1), and examples thereof may include homopolymers of methacrylate ester and copolymers of methacrylate ester with another monomer. Usually, alkyl methacrylate is used as methacrylate ester (M1). When the copolymer is made, acrylate ester, the aromatic vinyl compound and the vinyl cyan compound may be used as another monomer to be copolymerized with methacrylate ester.

The glass transition temperature of the methacrylate ester polymer (E) is preferably 40° C. or above. Those having a glass transition temperature of 60° C. or above are more preferable in terms of heat resistance. When the glass transition temperature of the methacrylate ester polymer (E) is lower than 40° C., this is not preferable because the heat resistance of the resulting film may become low. The glass transition temperature may be appropriately determined by changing a type and an amount of other monomers to be copolymerized with the methacrylate ester. The glass transition temperature of the homopolymer of methyl methacrylate is about 106° C. Thus, when methyl methacrylate is used as methacrylate ester, the glass transition temperature of the resulting methacrylate ester polymer (E) is usually 106° C. or below.

The particles (F) contained together with the methacrylate ester polymer (E) in the composition of the methacrylate ester polymer is not particularly limited, but it is preferable to have an external layer composed of the methacryl resin and an internal layer composed of a rubber having a crosslinked structure and have an average particle diameter of the internal layer in a range of 0.05 to 0.3 μm. It is more preferable in terms of film forming property, handling property and transparency that the average particle diameter of the internal layer in the particle (F) is 0.05 μm or more and 0.2 μm or less. When the average particle diameter of the internal layer in the particle (F) falls into this range, the film forming property of the film is stabilized and the film itself is excellent in flexibility and handling property. When the average particle diameter of the internal layer in the particle (F) is too small, the flexibility required for the film may become insufficient and the handling property tends to be reduced. On the other hand, when the average particle diameter is too large, a surface smoothness may be reduced and a transparency may be impaired, which is thus not preferable. The average particle diameter of the particles (F) including the external layer composed of the methacryl resin is preferably 0.07 to 0.5 μm and more preferably 0.1 to 0.45 μm. “Having” the external layer and the internal layer does not mean that the particle (F) is composed only of the external layer and the internal layer. The particle (F) may further have a layer other than them. For example, the particle (F) may further have a core internal layer inside the internal layer as described in the present Example.

The composition of the methacrylate ester polymer containing the methacrylate ester polymer (E) and the particles (F) contains 1 to 80% by weight, preferably 5 to 35% by weight and more preferably 10 to 25% by weight of the particles (F) on the basis of the entire amount of the composition being 100% by weight. When the amount of the particles is in this range, the film does not become fragile. Thus thereby the film forming property of the multilayer film of the present invention may be enhanced, and the multilayer film used for the present invention may be stretched without breaking. When the amount of the particles (F) is too small, it is likely to become difficult to form the film. When its amount is too large, the transparency and a surface hardness of the film are likely to be lost. The rate of the methacrylate ester polymer (E) may be 20 to 99% by weight. When an additive other than the methacrylate ester polymer (E) and the particles (F) is contained, this rate of the polymer may be appropriately adjusted.

The composition of the methacrylate ester polymer may contain ordinary additives such as ultraviolet light absorbers, organic dyes, pigments, inorganic dyes, antioxidants, antistatic agents and surfactants. Among them, the ultraviolet light absorber is preferably used for giving better weather resistance. Examples of the ultraviolet light absorber may include benzotriazole based ultraviolet light absorbers, 2-hydroxybenzophenone based ultraviolet light absorbers and phenyl salicylate ester based ultraviolet light absorbers.

These ultraviolet light absorbers may be used alone or in mixture of two or more. When the ultraviolet light absorber is added, the amount thereof is usually 0.1 parts by weight or more, preferably 0.3 parts by weight or more and preferably 2 parts by weight or less based on total 100 parts by weight of the methacrylate ester polymer (E) and the particles (F).

The melt viscosity of the composition of the methacrylate ester polymer is preferably 400 to 1,000 Pa·s and more preferably 450 to 900 Pas. The melt viscosity is the value measured at temperature of 250° C. and at a shearing speed of 150 sec⁻¹. Having such a melt viscosity may lead to less tendency of occurrence of the film braking upon stretching, and the strength upon stretching and upon using the product may be further improved.

In the present invention, it is preferable that the polystyrene resin and the methacrylate ester polymer (E) satisfy a relationship of Tg(A)>Tg(B)+20° C. wherein the glass transition temperatures of the polystyrene resin and the methacrylate ester polymer (E) are Tg(A) (° C.) and Tg(B) (° C.), respectively. If such a relationship is satisfied, stretching may effectively give the optical anisotropy to the layer a composed of the polystyrene resin, to thereby obtain the good stretched multilayer film.

For producing a multilayer film which is a laminate of the polystyrene resin which is the material of the layer a and the composition of the methacrylate ester polymer which is the material of the layer b, the production method therefor is not particularly limited, and the publicly known methods, e.g., molding methods by coextrusion such as a coextrusion T die method, a coextrusion inflation method and a coextrusion lamination method, film lamination molding methods such as a dry lamination, and coating molding methods may be utilized. Among them, the coextrusion molding method is preferable in terms of production efficiency and avoiding residual volatile component such as a solvent in the film. The extrusion temperature may be appropriately selected depending on the types of the polystyrene resin and the composition of the methacrylate ester polymer to be used.

The multilayer film is obtained by laminating the layer b on the both surfaces of the layer a. An adhesive layer or a tacky layer may be provided between the layer a and the layer b, but it is preferable to directly laminate the layer a and the layer b (i.e., the laminate having three layered structure of the layer b/layer a/layer b is made). In the multilayer film, the thickness of the layer b laminated on the both surfaces of the layer a is not particularly limited, and may be preferably 10 to 300 μm and 10 to 400 μm, respectively.

The stretched multilayer film is obtained by stretching the multilayer film. The stretched multilayer film may contain a layer A obtained by stretching the layer a and a layer B obtained by stretching the layer b. It is preferable that the stretched multilayer film is a stretched film having a three layered structure (layer B)/(layer A)/(layer B) obtained by stretching the multilayer film, i.e., the laminate having the three layered structure (layer b)/(layer a)/(layer b).

The stretching may be performed preferably by a monoaxial stretching or an oblique stretching, and more preferably by the monoaxial stretching or the oblique stretching using a tenter.

It is preferable that the stretched multilayer film has an interlayer delamination strength between the layer A and the layer B at 1.3 N/25 mm or more. The interlayer delamination strength is the value measured by delaminating at 180° at a tensile speed of 100 mm/minute in accordance with JIS K6854-2. Having such an interlayer delamination strength, the stretched multilayer film may obtain a high durability.

The stretched multilayer film preferably has a total light transmittance of 92% or more and a haze of 5% or less. Having such a high total light transmittance and such a low haze, the film can be used advantageously as an optically anisotropic element.

It is particularly preferable that the stretched multilayer film satisfies the formulae (1) and (2) wherein the total in-plane direction retardation of the layer A and the layer B measured using the light at a wavelength of 400 to 700 nm are Re(A) and Re(B), respectively, and also satisfies the formula (3) wherein the in-plane direction retardation and the thickness direction retardation measured with the light at a wavelength of 400 to 700 nm are Re and Rth, respectively.

|Re(A)|>|Re(B) Formula (1)

|Re(B)<20 nm Formula (2)

Rth/|Re|≦−0.5 Formula (3)

When Re(A), Re(B), Re and Rth satisfy these relationships, it is possible to obtain good optical properties when the stretched multilayer film is used for the optically anisotropic element.

The stretched multilayer film having Re(A), Re(B), Re and Rth satisfying the aforementioned relationships may be produced by appropriately controlling stretching conditions such as a stretching temperature and a stretching ratio. The stretching temperature is preferably Tg(a)−10° C. to the Tg(a)+20° C., and more preferably Tg(a)−5° C. to the Tg(a)+15° C. The stretching ratio is preferably 1.05 to 30 times and more preferably 1.1 to 10 times. When the stretching temperature and the stretching ratio are out of the aforementioned ranges, the orientation may become insufficient, and the refraction index anisotropy and thus the retardation may be insufficiently expressed, and the laminate is likely to be broken.

It is preferable that the stretched multilayer film has protrusions having a diameter of 0.001 to 0.1 μm on at least its surface and the amount of the protrusions is 50 to 500/30 μm². Having such protrusions, slip property of the stretched multilayer film may be enhanced and handling property of the stretched multilayer film may become good.

The method for producing other embodiments of the optically anisotropic element than the aforementioned particular stretched multilayer film is not particularly limited. Such an optically anisotropic element may be produced by preparing a pre-stretch laminate of the styrene resin and another resin and then stretching this pre-stretch laminate. Publicly known methods such as coextrusion molding, e.g., the coextrusion T die method, the coextrusion inflation method and the coextrusion lamination method, film lamination molding methods such as the dry lamination, and coating molding methods in which a resin solution is coated on a substrate resin film may be utilized as the method for preparing the pre-stretch laminate. Among them, the coextrusion molding is preferable in terms of production efficiency and avoiding residual volatile component such as a solvent in the film.

The method for stretching the pre-stretch laminate is not particularly limited, and conventionally and publicly known methods may be applied. Specific methods may include monoaxial stretching methods such as a method of monoaxially stretching in a lengthwise direction using the difference of peripheral speeds of roll surfaces, and a method of monoaxially stretching in a crosswise direction using a tenter; biaxial stretching methods such as a simultaneous biaxial stretching method wherein an interval of seizing clips is expanded for lengthwise stretching and distance between guiderails are expanded with an angle for crosswise stretching, and a sequential biaxial stretching method wherein a lengthwise stretching is performed utilizing the difference of peripheral speed between rolls, and then crosswise stretching is performed with a tenter which clips peripheral parts of the film; and methods of obliquely stretching using a tenter stretching machine capable of adding a sending force or a tensile force or an accepting force with speeds different at left side and right side in the crosswise or the lengthwise direction, or a tenter stretching machine capable of adding the sending force or the tensile force or the accepting force with the same speed at left side and right side in the crosswise or the lengthwise direction and wherein moving distances are the same and a stretching angle is fixed or the moving distances are different.

The periodic structure member used for the present invention is a structure member having a repeating structure on its surface. It is preferable that the other surface of the periodic structure member used for the present invention is a flat plane. The repeating structure on the plane of the periodic structure member may be a structure in which a concavo-convex repeating unit is repeated along a direction parallel with the plane. The shape of the repeating units on the plane of the periodic structure member may be uniform or varied.

Specific examples of the periodic structure member may include a prism row shape wherein a plurality of linear prism shapes are provided as the repeating unit, a shape wherein a plurality of pyramid shapes are provided as the repeating unit, a cylindrical row shape wherein a plurality of cylindrical shapes are provided as the repeating unit and a shape wherein a plurality of partial spheres are provided as the repeating unit. Among them, the linear prism shape, the pyramid shape or the cylindrical shape is preferable.

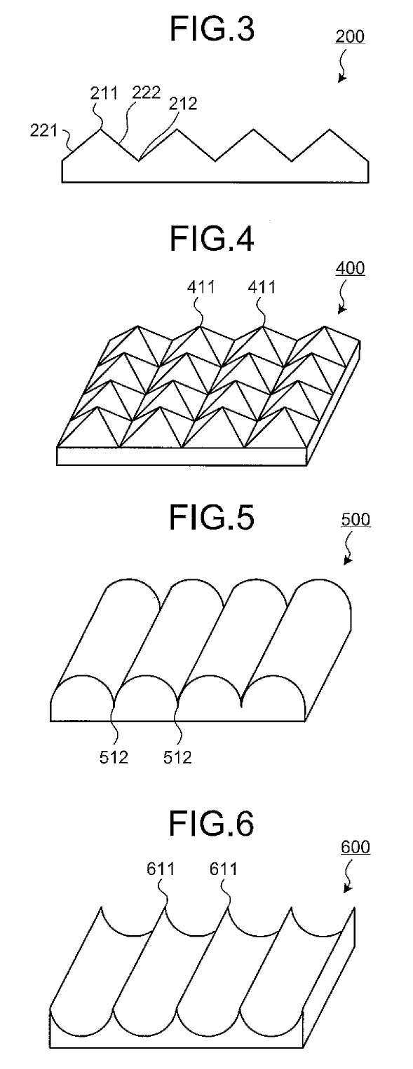

The linear prism shape is a shape of a polygon having a concave or convex cross sectional shape, and a specific example thereof is a triangle prism having a triangle cross section as identified as 200 in FIGS. 2 and 200 in FIG. 3.

The pyramid shape is a shape of a concave or convex polygonal pyramid, and a specific example thereof is a quadrangular pyramid identified as 400 in FIG. 4. In addition to the quadrangular pyramid in FIG. 4, other examples of the pyramid shape may include a triangular pyramid and a six-sided pyramid.

The cylindrical shape is a shape having a concave or convex semicircular cross section, and specific examples thereof may include those identified as 500 in FIGS. 5 and 600 in FIG. 6.

The periodic structure member has an effect to enhance the luminance in a front direction, and those having the unit having the pyramid shape or the partial sphere shape may further enhance the luminance in the front direction.

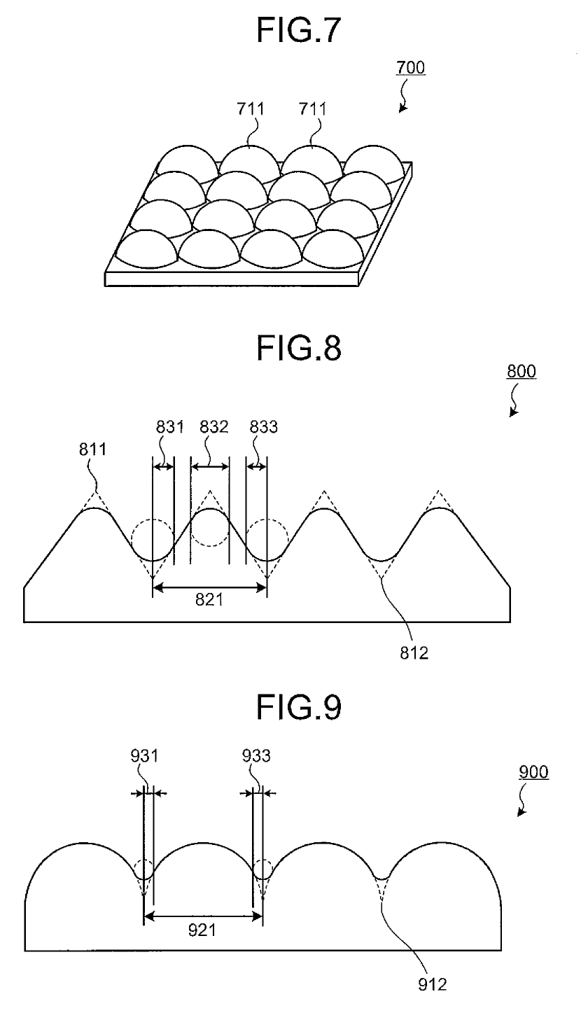

In the examples in FIGS. 2, 5, 6, 8 and 9, the repeating direction of the periodic structure member is one direction of a width direction of the plane (left and right direction in the drawings). In the examples in FIGS. 4 and 7, the repeating directions of the periodic structure member are two directions of the width direction and a length direction (direction represented as a perspective direction in perspective views). However, the repeating direction of the periodic structure member is not limited thereto, and may be any direction such as a diagonal direction on a rectangular plane.

In the example of the periodic structure member 200 in FIGS. 2 and 3, the linear prism composed of a pair of slants 221 and 222 is repeatedly provided on the plane to constitute the prism row shape.

The periodic structure member may have a structure wherein ridges of its repeating structure are given R-modification. R-modification on the ridge of the repeating structure herein means that an apex of the ridge in the periodic structure member is made into a roundish shape. The R-modification may also be given to valleys of the repeating structure if necessary. Specifically, the apex of the ridge and/or valley, e.g., the ridge 811 and the valley 812 in the periodic structure member 800 shown in FIG. 8 and the valley 912 in the periodic structure 900 shown in FIG. 9 are made into the roundish shapes. The R-modification is performed so that the diameter of a treated R portion becomes larger than the predetermined size with respect to the pitch of the periodic structure. Specifically, the R-modification may be given so that the value represented by [sum of diameters of R-modification in one pitch]/[length of pitch] is preferably 0.01 to 1.50 and more preferably 0.05 to 0.70. Explaining more specifically, in the example of the periodic structure member 800 shown in FIG. 8, the sum of the diameters of the R-modification in one pitch 821 is represented by a sum of the lengths of arrows 831 to 833. Therefore, it is preferable that the R-modification is given so that the value obtained by dividing the sum of the lengths of the arrows 831 to 833 by the pitch 821 is in the aforementioned preferable range. In the case of the periodic structure member 900 shown in FIG. 9, the sum of the diameters of the R-modification in one pitch 921 is represented by the sum of the lengths of arrows 931 and 933. Therefore, it is preferable that the R-modification is given so that the value obtained by dividing the sum of the lengths of the arrows 931 and 933 by the pitch 921 is in the aforementioned preferable range. It is also preferable that the periodic structure member has a structure wherein the surface of the repeating structure is roughened. Specifically, it is preferable that an arithmetic average roughness Ra does not exceed 1/10 of the pitch in the periodic structure member and is in the range of 0.1 to 100 μm. Employing the periodic structure member to which such an R-modification and/or roughening treatment has been given, it is possible to inhibit the occurrence of the color unevenness. The treatment for giving the roughening is not particularly limited, and examples thereof may include a blast treatment (wet or dry) on a mold which transfers the repeating structure or a periodic structure to the periodic structure member. The aforementioned arithmetic average roughness Ra may be measured using an appropriate surface shape measurement apparatus (e.g., apparatus name “NewView 6200” supplied from ZYGO).

In the periodic structure member, it is preferable that the pitch of one cycle in the repeating structure is 10 μm to 1,000 μm. One cycle of the repeating structure is, for example, the distance between the ridges 211 in the adjacent linear prisms and the distance between the valleys 212 of the linear prisms in the example of the periodic structure members 200 shown in FIGS. 2 and 3. Also for example, in the periodic structure members 500 and 600 shown in FIGS. 5 and 6, the distance between the valleys 512 and between the ridges 611 in the adjacent cylindrical shapes may be regarded as one cycle of the repeating structure. In the examples of the periodic structure members 400 and 700 in FIGS. 4 and 7 having the unit having the pyramid and the partial sphere, the distance between the apexes 411 in the adjacent pyramids or the distance between the apexes 711 in the adjacent semicircular shapes may be regarded as the one cycle of the repeating structure. Concerning those having cycles in a plurality of directions such as the lengthwise and crosswise directions as shown in the periodic structure members shown in FIGS. 4 and 7, it is preferable that at least one pitch in the respective cycles is in this range, and it is more preferable that the pitches in the all cycles are in this range. Configuring the pitch of the one cycle within this range, it is possible to accomplish the reduction of the luminance unevenness well.

In the periodic structure member, it is preferable that its thickness is 1.2 to 20 times the maximum value of the height of the repeating structure. The maximum value of the height of the repeating structure is, for example, the difference between the ridges 211 and the valleys 212 in the examples of the periodic structure members 200 shown in FIGS. 2 and 3. By adjusting the ratio to 20 times or less, it is possible to inhibit the occurrence of the color unevenness attributed to the optical anisotropy of the periodic structure member. By adjusting the ratio to 1.2 times or more, it is possible to keep the sufficient mechanical strength. Meanwhile, the thickness of the periodic structure member is the thickness including the periodic structure. That is, the distance from the apex of the periodic structure on the surface having the periodic structure to the other surface may be regarded as the thickness.

The material which composes the periodic structure member preferably has a light diffusibility. Having the light diffusibility herein refers to that the haze of the periodic structure member is 5% or more. The haze of the periodic structure member may be within the range of preferably 10 to 90%, more preferably 10 to 70% and particularly preferably 20 to 50%. The haze may be adjusted by using a material for the periodic structure member containing a light diffusing agent dispersed in a transparent resin, and adjusting the content of the light diffusing agent. In the material which composes the periodic structure member, it is preferable that the maximum value of its refraction index anisotropy Δn is less than 0.05. Adjusting the light diffusibility and the refraction index anisotropy of the periodic structure member within the aforementioned preferable ranges, it is possible to inhibit the occurrence of the color unevenness attributed to the optical anisotropy of the periodic structure member. The Δn may be measured in the same way as in the aforementioned Re and Rth using the phase shift measurement apparatus and the maximum value of the values measured in this manner may be regarded as the maximum value of the Δn.

As the material of the periodic structure member, it is possible to use a glass, a mixture of two or more species of resins which do not tend to be mutually compatible, a transparent resin in which a light diffusing agent is dispersed, and one species of the transparent resin. Among them, the resin is preferable in terms of light weight and good moldability. One species of the transparent resin is preferable in terms of facile luminance enhancement. A transparent resin in which a light diffusing agent is dispersed is preferable in terms of good adjustability of the total light transmittance and the haze.

The transparent resin is a resin having a total light transmittance of 70% or more measured in accordance with JIS K7361-1 using a plate having smooth surfaces on both surfaces and the thickness of 2 mm, and examples thereof may include polyethylene, propylene-ethylene copolymers, polypropylene, polystyrene, copolymers of an aromatic vinyl monomer and alkyl (meth)acrylate ester having a lower alkyl group, polyethylene terephthalate, terephthalic acid-ethylene glycol-cyclohexane dimethanol copolymer, polycarbonate, acryl resins and resins having the alicyclic structure. (Meth) acrylic acid means acrylic acid and methacrylic acid. Among them, polycarbonate, polystyrene, copolymers of the aromatic vinyl based monomer with alkyl (meth)acrylate ester having the lower alkyl group containing 10% or more of the aromatic vinyl monomer, and resins having the alicyclic structure are preferable as the transparent resin because of low tendency of shape changing due to moisture absorption. In particular, the resin having the alicyclic structure described above as the example of other thermoplastic resins for the optically anisotropic element may be used suitably.

The light diffusing agent is a particle having a nature to diffuse a light ray and is broadly classified into an inorganic filler and an organic filler. Examples of the inorganic filler may include silica, aluminium hydroxide, aluminium oxide, titanium oxide, zinc oxide, barium sulfate, magnesium silicate and mixtures thereof. Examples of the organic filler may include acryl resins, polyurethane, polyvinyl chloride, polystyrene resins, polyacrylonitrile, polyamide, polysiloxane resins, melamine resins and benzoguanamine resins. Among them, as the organic filler, fine particles composed of the polystyrene resin, the polysiloxane resin and crosslinked products thereof are preferable in terms of high diffusibility, high heat resistance and no coloration (yellowing) upon molding. Among them, the fine particle composed of the crosslinked product of the polysiloxane resin is more preferable in terms of more excellent heat resistance.

Examples of the shape of the light diffusing agent may include spherical, cubic, needle, bar, spindle, platy, scale and fibrous shapes, and among them, the spherical shape is preferable because directions of the light diffused thereby may be isotropic. The light diffusing agent is used by uniformly dispersing in the transparent resin.

The ratio of the light diffusing agent to be dispersed in the transparent resin may be appropriately selected depending on the thickness and the desired haze of the periodic structure member.

The total light transmittance is the value obtained by the measurement in accordance with JIS K7361-1 as to a plate having flat surfaces on both surfaces and a thickness of 2 mm. The haze is the value obtained by the measurement in accordance with JIS K7136 as to a plate having flat surfaces on both surfaces and a thickness of 2 mm.

The brightness enhancement film of the present invention has a structure wherein the circular polarization separation element, the optically anisotropic element and the periodic structure member are integrated in this order. Specifically, the platy or film-like shaped circular polarization separation element, the optically anisotropic element and the periodic structure member are laminated in this order directly or via another layer. Having such an integrated structure, it is possible to obtain a brightness enhancement film which may reduce the color unevenness and achieve enhancement of luminance and reduction of luminance unevenness. The periodic structure member is typically integrated so that the surface opposite to the surface having the repeating structure is in contact with the optically anisotropic element. The method for obtaining such an integrated structure is not particularly limited, but these may be separately prepared and then integrated together by adhesion with, if necessary, an adhesive agent or a tacky agent.

The adhesive agent and the tacky agent are not particularly limited. The adhesive agent for use may be appropriately selected from those containing, as a base polymer, polymers such as acrylic polymers, silicone based polymers, polyester, polyurethane, polyamide, polyvinyl ether, vinyl acetate/vinyl chloride copolymer, modified olefin, epoxy based polymers, fluorine based polymers, and rubbers such as natural rubbers and synthetic rubbers. In particular, it is preferable to use those which has good optical transparency, adequate wettability, aggregability, and tackiness in an adhesive manner, as well as weather resistance and heat resistance. Different ones may be used for each layer of adhesive agent and tacky agent.

The adhesive agent and the tacky agent may contain a crosslinking agent suitable for the base polymer. The adhesive agent may contain additives such as natural and synthetic resins, in particular, adhesiveness-imparting resins, fillers and pigments composed of glass fibers, glass beads, metal powders and the other inorganic powders, coloring agents and antioxidants. The adhesive agent may also contain fine particles to give an adhesive layer which exhibits light diffusibility.

The adhesive agent and the tacky agent are usually used in a form of an adhesive agent solution wherein the base polymer or its composition is dissolved or dispersed in a solvent and the concentration of the solid content is about 10 to 50% by weight. As the solvent for use, organic solvents such as toluene and ethyl acetate, and water may be appropriately selected depending on the type of the adhesive agent.

The adhesive layer or the tacky layer may be formed directly on the element. Alternatively, the adhesive layer or the tacky layer may be formed on a separator, and the layer may be then transferred onto each element. The method for coating with the adhesive agent or with the tacky agent is not particularly limited, and examples thereof may include a roll coating method, a gravure coating method, a spin coating method and a bar coating method. The thickness of the adhesive layer or the tacky layer is adjusted to be about 0.1 to 20 μm.

In the brightness enhancement film of the present invention, it is preferable that a symmetric axis of the repeating structure in the periodic structure member is approximately parallel with or approximately perpendicular to a polarization direction of the light emitted from the optically anisotropic element. The polarization direction of the light emitted from the optically anisotropic element is typically the direction parallel with the plane of the optically anisotropic element and has an angle of 45° with respect to the in-plane slow axis direction. The symmetric axis of the repeating structure is, for example, a ridge direction of the ridge 211 in the linear prism in the case of the periodic structure member 200 in FIG. 2 having the repeating structure of the linear prism shape. “Being approximately parallel” and “being approximately perpendicular” refers to being within ±3° from the parallel direction and the perpendicular direction.

In addition to the circular polarization separation element, the optically anisotropic element and the periodic structure member, the brightness enhancement film of the present invention may also have any optional constituent, such as a support substrate and the orientation film for producing the circular polarization separation element, and an adhesive layer for integrating the respective layers.

The brightness enhancement film of the present invention may be used as the constituent for the display devices such as liquid crystal display devices. For example, the brightness enhancement film of the present invention may be disposed between the backlight and the liquid crystal cell in the liquid crystal display device, for accomplishing luminance enhancement. More specifically, the brightness enhancement film of the present invention may be disposed so that the surface of the circular polarization separation element faces the backlight and the surface of the periodic structure member faces the liquid crystal cell, so that the linear polarization emitted from the periodic structure member enters the liquid crystal cell. When the polarizing plate is disposed between the periodic structure member and the liquid crystal cell, the brightness enhancement film of the present invention is usually disposed so that a polarization plane of the linear polarization emitted from the periodic structure member is parallel with the transmission axis of the polarizing plate. When the backlight is a direct-type backlight having a plurality of parallel linear light sources, the film of the present invention may preferably be disposed in a direction so that the symmetric axis of the repeating structure in the periodic structure member is parallel with the linear light sources.

### EXAMPLES

The present invention will be described in more detail with reference to the following Examples, but the present invention is not limited thereto In the following, “parts” and “%” represent parts by weight and % by weight, respectively, unless otherwise specified.

### Production Example 1

### Preparation of Circular Polarization Separation Element A

(1) A plasma treatment was given to both surfaces of a support substrate (film made of a norbornene based polymer) (brand name: Zeonor Film ZF14, thickness: 100 μm, supplied from Optes Inc.). On the surface of this support substrate, a solution composed of 10 parts of polyvinyl alcohol and 371 parts of water was applied and dried. Then rubbing treatment was performed thereon, to form an orientation film having a thickness of 1 μm.

Subsequently, 94.13 parts of a nematic liquid crystal compound (brand name: LC242 supplied from BASF), 5.87 parts of a chiral agent (brand name: LC756 supplied from BASF), 3.1 parts of a light absorber (brand name: Irgacure 907 supplied from Ciba Specialty Chemicals) and 0.1 parts of a surfactant (brand name: KH-40 supplied from Seimi Chemical Co., Ltd.) were dissolved in 155 parts of methyl ethyl ketone to obtain a solution. This solution was filtrated through a CD/X syringe filter made of polyfluoroethylene and having a pore diameter of 2 μm, to prepare a liquid crystal coating solution.

The liquid crystal coating solution was applied on the orientation film at a thickness which would give the dried film thickness of 4 μm. The coating layer was irradiated with ultraviolet light (UV-A) having an illumination intensity of 0.2 mW/cm² using an ultraviolet light irradiation apparatus (apparatus name: EXECURE 3000-W supplied from HOYA SCHOTT) and a band pass filter of 313 nm. Then, the coating layer was left stand in an oven at 100° C. for 2 minutes. Then the layer was irradiated with an ultraviolet light in an integrated amount of 150 mJ/cm² using the aforementioned ultraviolet light irradiation apparatus. As a result of the aforementioned steps, a cholesteric resin layer A having a reflection bandwidth (half value width) of 100 nm and a center wavelength of 450 nm was formed on the orientation film to obtain a laminate A composed of three layers of (support substrate)-(orientation film)-(cholesteric resin layer A).

(2) An orientation film and a cholesteric resin layer B were formed on another support substrate to obtain a laminate B composed of three layers of (support substrate)-(orientation film)-(cholesteric resin layer B), in the same way as in the aforementioned (1) except that the amount of the nematic liquid crystal compound was changed to 95.28 parts and the amount of the chiral agent was changed to 4.72 parts. The laminate B had a reflection bandwidth (half value width) of 120 nm and a center wavelength of 560 nm.

(3) An orientation film and a cholesteric resin layer C were formed on another support substrate to obtain a laminate C composed of three layers of (support substrate)-(orientation film)-(cholesteric resin layer C), in the same way as in the aforementioned (1) except that the amount of the nematic liquid crystal compound was changed to 96.11 parts and the amount of the chiral agent was changed to 3.89 parts. The laminate C had a reflection bandwidth (half value width) of 140 nm and a center wavelength was 680 nm.

(4) The laminates A to C obtained in the aforementioned (1) to (3) were integrated by adhesion so as to constitute layers in the order of (support substrate)-(orientation film)-(cholesteric resin layer C)-(support substrate)-(orientation film)-(cholesteric resin layer B)-(support substrate)-(orientation film)-(cholesteric resin layer A), using a tacky agent for optical use (“8142” supplied from Sumitomo 3M Ltd., thickness: 50 μm), and the resulting product was cut out into a size of 200 mm×200 mm, to obtain a circular polarization separation element A. The reflection bandwidth of the circular polarization separation element A was 400 to 750 nm.

### Production Example 2

### Optically Anisotropic Element B

(5) A monomer composition composed of 97.8% by weight of methyl methacrylate and 2.2% by weight of methyl acrylate was polymerized by bulk polymerization to obtain resin pellets.

(6) Rubber particles were produced in accordance with Example 3 in JP Sho-55-27576-B Publication. This rubber particle has a spherical three layer structure. The core internal layer thereof is made of a crosslinked polymer composed of methyl methacrylate and a small amount of allyl methacrylate. The internal layer of the particles is made of a soft elastic copolymer obtained by crosslinking copolymerization of butyl acrylate and styrene as major components, and a small amount of ally acrylate. The external layer is made of a hard polymer of methyl methacrylate and a small amount of ethyl acrylate. The average particle diameter of the internal layer was 0.19 μm, and the particle diameter including the external layer was 0.22 μm.

Subsequently, 70 parts by weight of the resin pellets and 30 parts by weight of the rubber particles were mixed, and the mixture was melted and kneaded using a biaxial extruder, to obtain a methacrylate ester polymer composition A (glass transition temperature: 105° C.).

(7) The methacrylate ester polymer composition A (layer b) and a polystyrene resin (layer a) (styrene-maleic acid anhydrate copolymer, glass transition temperature: 130° C.) were subjected to co-extrusion molding at 280° C. to obtain a multilayer film having three layer structure of (layer b)/(layer a)/(layer b) having thickness of 45/70/45 μm, respectively. This multilayer film was stretched monoaxially in a crosswise direction using a tenter at a stretching temperature of 128° C., a stretched ratio of 1.4 times and a stretching speed of 10 m/minutes, and then cut out into the size of 200 mm×200 mm so that the slow axis thereof was in a diagonal direction, to obtain an optically anisotropic element B wherein a retardation in an in-plane direction Re was 141 nm and a retardation in a thickness direction Rth was 151 nm at a wavelength of 550 nm.

### Production Example 3

### Optically Anisotropic Element C)

(8) A film made of a norbornene based polymer (brand name: Zeonor Film ZF14, thickness: 100 μm, supplied from Optes Inc.) was monoaxially stretched, and cut out into the size of 200 mm×200 mm so that the slow axis thereof was in a diagonal direction, to obtain an optically anisotropic element C wherein a retardation in an in-plane direction Re was 135 nm and a retardation in an thickness direction Rth was 70 nm at the wavelength of 550 nm.

### Production Example 4

### Periodic Structure Member D

(9) A cutting was given to a metal block surface of a mold of 200 mm×200 mm to form a triangle prism shape parallel with one side of the block. The apex angle of the triangle prism shape was 90 degrees, the cycle (distance) between adjacent ridges was 40 μm and the depth of the triangle prism shape was 20 μm.

(10) A film made of a norbornene based polymer (brand name: Zeonor Film ZF14 supplied from Optes Inc., thickness: 100 μm, refraction index anisotropy Δn=0.03) whose surface had been dissolved with cyclohexane was pressed to the mold obtained in the aforementioned (9) and the prism shape was transferred onto the film, to obtain a periodic structure member D schematically shown in FIGS. 2 and 3 and having a prism row structure composed of a plurality of linear prisms (triangle prisms).

### Production Example 5

### Periodic Structure Member E

(11) The periodic structure member D was obtained in the same way as in the aforementioned (10). A wet blasting treatment using particles having the particle diameter of about 16 μm was given thereto for roughening the surface, to obtain a periodic structure member E.

### Production Example 6

### Periodic Structure Member F)

(13) Using the mold obtained in the aforementioned (9), a press working was given to a polycarbonate film having a thickness of 200 μm and a refraction index anisotropy Δn=0.2, to obtain a periodic structure member F.

### Production Example 7

### Periodic Structure Member G)

(14) The periodic structure member D was obtained in the same way as in the aforementioned (10). An R modification was given to the ridges of the prism rows so that R (curvature radius) was configured to be 5 μm, to obtain a periodic structure member G.

### Production Example 8

### Periodic Structure Member H

(15) A cutting was given to a metal block surface of a mold of 200 mm×200 mm to form a cylindrical shape on a surface of the block. The radius of the cylindrical shape was 20 μm.

(16) A film made of a norbornene based polymer (brand name: Zeonor Film ZF14 supplied from Optes Inc., thickness: 200 μm, refraction index anisotropy Δn=0.03) was pressed to the mold obtained in the aforementioned (15) and the cylindrical shape was transferred onto the film, to obtain a periodic structure member H schematically shown in FIG. 5 and having a cylindrical structure.

### Production Example 9

### Periodic Structure Member I

(17) A film (thickness: 200 μm, refraction index anisotropy Δn=0.04) made of a norbornene based polymer containing particles composed of a crosslinked product of a polysiloxane polymer having an average particle diameter of 2 μm at a certain ratio so that the film had a haze of 25% was prepared. To the mold obtained in the aforementioned (9), the film was pressed to transfer the prism shape, to obtain a periodic structure member I schematically shown in FIGS. 2 and 3 and having a prism row structure composed of a plurality of linear prisms.

### Production Example 10

### Periodic Structure Member J

(18) A cutting was given to a metal block surface of a mold of 200 mm×200 mm to form a quadrangular pyramid shape. The distance (cycle) between the apexes of adjacent quadrangular pyramids in the quadrangular pyramid shape was 40 μm and the depth of the quadrangular pyramid was 20 μm.

(19) A film made of a norbornene based polymer (brand name: Zeonor Film ZF14 supplied from Optes Inc., thickness: 200 μm, refraction index anisotropy Δn=0.03) whose surface had been dissolved with cyclohexane was pressed to the mold obtained in the aforementioned (18) and the quadrangular pyramid shape was transferred onto the film, to obtain a periodic structure member J schematically shown in FIG. 4 and having a unit structure of the quadrangular pyramid shape having 40 μm square and a height of 20 μm.

### Example 1

### Production of Assembly

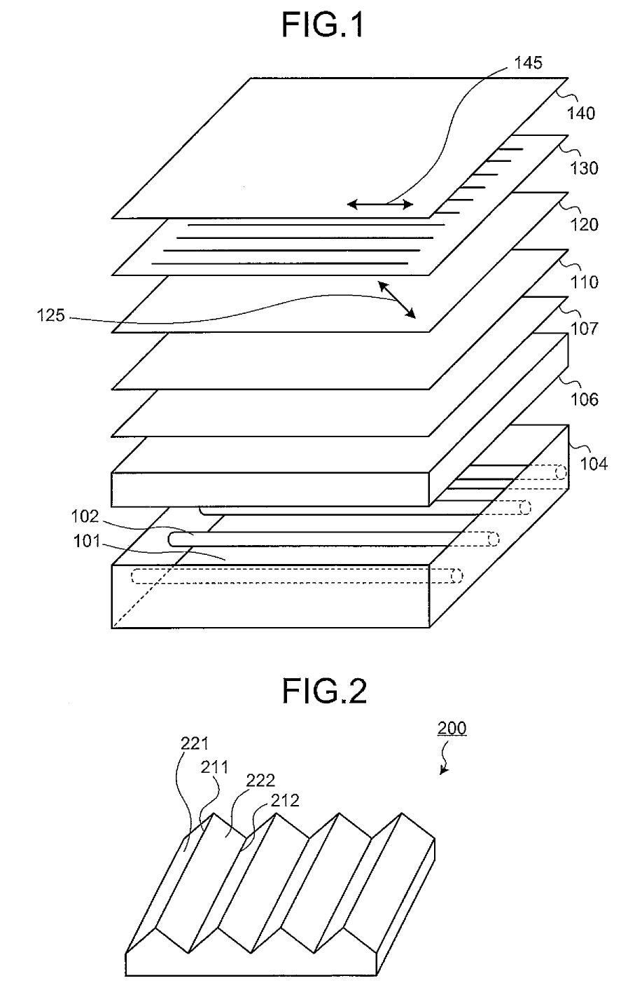

An assembly schematically shown in FIG. 1 including a lighting system 104, a circular polarization separation element 110, an optically anisotropic element 120, a periodic structure member 130 and a linear polarizing plate 140 was produced. The lighting system 104 for use was equipped with a housing of 180 mm×180 mm×depth 15 mm, which was provided with a reflecting plate 101 and linear light sources 102, on which a diffusion plate 106 and a diffusion sheet 107 had been placed. The lamp pitch of the linear light source was 25 mm. A flat plate having a total light transmittance of 55% and the haze of 99% was used as the diffusion plate 106. The brand name “188GM3” supplied from Kimoto Co., Ltd. was used as the diffusion sheet 107.

As the circular polarization separation element 110, the optically anisotropic element 120 and the periodic structure member 130, the circular polarization separation element A, the optically anisotropic element B and the periodic structure member D obtained in an aforementioned manner were integrated in this order by adhesion using a tacky agent (“8142” supplied from Sumitomo 3M Ltd., thickness: 50 μm) to obtain a brightness enhancement film of the present invention. Upon preparing this film, the circular polarization separation element A was located so that the cholesteric resin layer C was on the visible side (upper side in FIG. 1). The periodic structure member D was located so that the prism row structure was on the visible side and the longitudinal direction of the prism row was parallel with the longitudinal direction of the linear light sources 102 in the lighting system 104. This brightness enhancement film was placed on the diffusion sheet 107, and a polarizing plate (brand name: “HLC2-5618 supplied from Sanritz Corporation) 140 was placed thereon, to thereby obtain an assembly. In the assembly, each constituent was arranged so that a transmission axis 145 of the polarizing plate 140 intersected with a slow axis 125 of the optically anisotropic element 120 at an angle of 45° and the transmission axis 145 was parallel with the longitudinal direction of the prism row in the periodic structure member 130 and the longitudinal direction of the linear light sources 102. In FIG. 1, each constituent is separately shown for the sake of explanation. However, in the actual assembly, the brightness enhancement film and the polarizing plate were placed on the housing of the lighting system in a closely attached manner.

(Evaluation 1) Luminance

The lighting system was turned on, and the luminance in the front direction of the assembly was measured using a luminometer (product name: BM-7 supplied from TOPCON). With respect to this measurement result as a value of 1, other measurement results in Examples and Comparative Examples are shown as relative values in Table 1.

(Evaluation 2) Color, Unevenness

The lighting system was turned on, and the color and the unevenness in the front direction and the oblique direction (polar angle 60 degrees) of the assembly were evaluated visually. The results are shown in Table 1. Evaluation criteria were as follows.

### Color

5: Insertion of the brightness enhancement film causes no recognizable change and display quality is kept in a good state.

4: Insertion of the brightness enhancement film causes slight recognizable change although display quality is in a good state.

3: Insertion of the brightness enhancement film causes change although display quality remains at a practical level.

2: Insertion of the brightness enhancement film causes change which reduces display quality.

1: Insertion of the brightness enhancement film causes significant change which reduces display quality below the practical level.

### Unevenness

5: Insertion of the brightness enhancement film causes no recognizable unevenness.

3: Insertion of the brightness enhancement film causes unevenness although display quality remains at a practical level.

1: Insertion of the brightness enhancement film apparently causes unevenness and affects display quality.

### Example 2

An assembly was made in the same way as in Example 1 except that the periodic structure member E was used in place of the periodic structure member D, and the luminance and the color and the unevenness were evaluated. The results are shown in Table 1.

### Example 3

An assembly was made in the same way as in Example 1 except that the periodic structure member G was used in place of the periodic structure member D, and the luminance and the color and the unevenness were evaluated. The results are shown in Table 1.

### Example 4

An assembly was made in the same way as in Example 1 except that the periodic structure member H was used in place of the periodic structure member D, and the luminance and the color and the unevenness were evaluated. The results are shown in Table 1.

### Example 5

An assembly was made in the same way as in Example 1 except that the periodic structure member F was used in place of the periodic structure member D, and the luminance and the color and the unevenness were evaluated. The results are shown in Table 1.

### Example 6

An assembly was made in the same way as in Example 1 except that the periodic structure member I was used in place of the periodic structure member D, and the luminance and the color and the unevenness were evaluated. The results are shown in Table 1.

### Example 7

An assembly was made in the same way as in Example 1 except that the periodic structure member J was used in place of the periodic structure member D, and the luminance and the color and the unevenness were evaluated. The results are shown in Table 1.

### Comparative Example 1

An assembly was made in the same way as in Example 1 except that no periodic structure member was used, and the luminance and the color and the unevenness were evaluated. The results are shown in Table 1.

### Comparative Example 2

An assembly was made in the same way as in Example 1 except that the optically anisotropic element C was used in place of the optically anisotropic element B, and the luminance and the color and the unevenness were evaluated. The results are shown in Table 1.

### Comparative Example 3

An assembly was made in the same way as in Example 1 except that, although the circular polarization separation element A was integrated by adhesion with the optically anisotropic element, the optically anisotropic element B was not integrated by adhesion with the periodic structure member D (not integrated) and the periodic structure member E was simply placed on the optically anisotropic element B. The order of each layer and the relationship of the transmission axis, the slow axis and the direction of the linear light sources in this assembly were the same as in the assembly in Example 1. The luminance and the color and the unevenness in this assembly were evaluated in the same way as in Example 1. The results are shown in Table 1.

As shown in Table 1, when the brightness enhancement film of the present invention was employed, the good results were obtained for the luminance and the color, and the good results were also obtained for the unevenness, although slight rainbow unevenness was observed. On the contrary, in Comparative Example 1 wherein no periodic structure member was included in the constitution, the remarkable reduction of luminance and the remarkable luminance unevenness were observed. In Comparative Example 2 wherein the Rth value was out of the definition of the present invention, the color was extremely inferior. In Comparative Example 3 wherein the optically anisotropic element was not integrated with the periodic structure member, the luminance was insufficient and the unevenness was remarkable and totally poor results were observed.

TABLE 1

| Examples and | | | | |
|---|---|---|---|---|
| Comparative | | Color taste | Unevenness | |
| Examples | Luminance | (front, oblique) | Front | Oblique |
| Example 1 | 1 | 3 | 5 | 3*1 |
| Example 2 | 0.98 | 4 | 5 | 5 |
| Example 3 | 0.97 | 4 | 5 | 5 |
| Example 4 | 0.95 | 4 | 5 | 5 |
| Example 5 | 0.98 | 3 | 3*2 | 3*2 |
| Example 6 | 0.95 | 5 | 5 | 5 |
| Example 7 | 1.3 | 3 | 5 | 3*1 |
| Comparative | 0.7 | 3 | 1*3 | 1*3 |
| Example 1 | | | | |
| Comparative | 0.98 | 1 | 5 | 3*1 |
| Example 2 | | | | |
| Comparative | 0.91 | 3 | 5 | 3*1 |
| Example 3 | | | | |

*1: Rainbow unevenness was observed.
*2: Color unevenness attributed to the retardation of polycarbonate was observed.
*3: Remarkable unevenness due to cold cathode tubes was observed.

1. A brightness enhancement film comprising:
a circular polarization separation element,
an optically anisotropic element wherein a retardation in an in-plane direction Re is about one fourth of a transmitting light and a retardation in a thickness direction Rth is less than 0 nm, and
a periodic structure member having a repeating structure on a surface thereof,
said circular polarization separation element, said optically anisotropic element and said periodic structure member being integrated in this order.

2. The brightness enhancement film according to claim 1 wherein said circular polarization separation element has a resin layer having a cholesteric regularity.

3. The brightness enhancement film according to claim 1 wherein said repeating structure in said periodic structure member has a repeating unit of a linear prism shape, a cylindrical shape or a pyramid shape.

4. The brightness enhancement film according to claim 1 wherein a ridge of the repeating structure in said periodic structure member is given R-modification.

5. The brightness enhancement film according to claim 1 wherein a surface of the repeating structure in said periodic structure member is roughened.

6. The brightness enhancement film according to claim 1 wherein said periodic structure member is composed of a material having a light diffusibility.

7. A liquid crystal display device comprising the brightness enhancement film according to claim 1.
